(19) United States
(12) Patent Application Publication
(10) Pub. No.: US 2026/0093215 A1
(43) Pub. Date: Apr. 2, 2026

(54) DATA CENTER ENERGY CONTROL

(71) Applicant: Verrus, LLC, Beverly Hills, CA (US)

(72) Inventors: Anand Ramesh, Los Altos, CA (US); Jimmy Clidaras, Boca Raton, FL (US); Christopher Alan Coco, San Francisco, CA (US); Matthieu Frederic Jean-Jacques Monsch, Seattle, WA (US); Saurav Talukdar, San Jose, CA (US); Jeremy Alan Rice, Santa Monica, CA (US); Nelson Louis Abramson, Santa Monica, CA (US); Benjamin Ray Wheeler, San Francisco, CA (US); Nithya Manickam, Redwood City, CA (US); Carlos Rios, San Mateo, CA (US)

(21) Appl. No.: 18/902,448

(22) Filed: Sep. 30, 2024

(51) Int. Cl. G05B 15/02; G06F 1/20

(52) U.S. Cl. CPC G05B 15/02; G06F 1/206

(57) ABSTRACT

A computer-implemented method for managing electrical and cooling supplies for a computer data center is disclosed, which includes identifying, for a computer data center, an expected need for cooling and electrical power during a future time; selecting, from among multiple different electrical power sources that include one or more electric utility sources, one or more electrical power sources for the data center corresponding to the future time; selecting one or more cooling sources for the data center corresponding to the future time; and serving the data center to be served using the selected one or more electrical power sources and one or more selected cooling sources over a time corresponding to the future time, wherein selecting the one or more electrical power sources and one or more cooling sources comprises applying a parameter to minimize an unfavorable result associated with operating the computer data center.

### TECHNICAL FIELD

This document generally describes technology related to computer-controlled management of energy-using and energy-providing components associated with computer data centers.

### BACKGROUND

Computer data centers continue to grow in their size and in their importance to the economy. Many now cost over $1 billion to construct and bring to operation (and often much more), with hundreds or thousands of computer racks inside, and hundreds of thousands processors (e.g., for processing search queries or other requests in real-time, or training AI models over a longer period with a more flexible schedule).

High levels of computer processing generally require relatively high levels of electrical power input to operate the computers in a data center. The conversion of that electricity to computing work then creates heat, and that heat needs to be dispersed. Cooling systems (with, e.g., fans, pumps, and compressors) can then require additional electrical power to perform such dissipation of heat. Additional auxiliary systems may further require electrical power, such as for lighting, control systems, and equipment for servicing and repairing the computing and other equipment.

### SUMMARY

This document generally describes computer-based technology for technologically managing the computing and auxiliary services for a computer data center both effectively and efficiently, and with high availability. In particular, the systems and methods described here may allow a data center to carry out its compute needs along with coordinated management of cooling and other systems that are auxiliary to the compute. Such operation may be directed toward minimizing cost; minimizing environmental effect; maximizing compute; maximizing the lifespan of computing, cooling, and/or electrical equipment; or obtaining similar goals individually or in combination. Such resources for a data center generally require electricity to operate, and the systems and methods described here aim to match electrical supply to electrical needs throughout one or more data center facilities. Such systems and methods are also dynamic, in that the level of needed compute (and thus the level of generated heat and required cooling), the availability or unavailability of equipment (e.g., because it is depleted or is subject to maintenance or repair), the ambient weather conditions, and the costs of resources vary over time, and sometimes vary quickly over time—so the systems and methods described here adapt to such variability automatically or semi-automatically so as to maintain desired parameters like energy savings.

More particularly, a data center management system is described here that models the computing and auxiliary components of a data center. The system identifies future energy needs, such as for operating and cooling equipment in the data center, identifies a predicted need for energy to serve those future needs, and selects sources for providing such energy (both mechanical and electrical)—including electrical supply from power generators (e.g., diesel generators, solar voltaic systems, wind generators, and geo-thermal electrical generation), energy storage sub-systems (e.g., batteries, hydrogen, and thermal storage such as cold brine), and from one or more grid power supply systems. The system then causes selected devices to be operated to provide the cooling or other services needed by the data center. Such actions may be taken repeatedly during the operation of the data center, including multiple times per hour, multiple times per minute, or even multiple times per second. The particular actions may also vary over time, both with respect to changes in the environment (e.g., change in compute need, change in outdoor temperature, or change in grid energy pricing) and changes in the system itself (e.g., increase/decrease in compute load, taking a device off-line for failure or maintenance, etc.).

As one example, the system can determine that a data center is required to perform a certain level of non-time-sensitive compute in the next n days or hours, such as background indexing of large data sets or the training of a particular AI model. The system may also have access to models that indicate likely continuing short-term compute requirements, such as levels of queries received from users of the system at particular times of the day on particular days of the week at particular times of the year. The system can then generate a compute forecast that varies across an upcoming time period (e.g., that combines predicted but unknown loads with requested compute jobs). The system may then determine its ability to respond to such requirements in the time period, such as to provide cooling and also to provide electricity for generating the compute (operating servers and network equipment, among other things) and for powering the cooling (operating fans and pumps, among other things). The system may incorporate or cooperate with cluster schedules that perform scheduling on the compute side.

The models to which the system has access may also indicate the limits on certain resources and the costs of those resources over time. For example, if it is currently 8 p.m., the local grid shifts to much lower off-peak rates at 9 p.m., and the data center has 30 minutes of available battery power, the system could delay non-time-sensitive compute for 30 minutes, thereby allowing the battery bank to provide 30 minutes of power for the data center (for time-sensitive compute), and then shifting to full grid power at 9 p.m., for full compute, ancillary operations such as cooling, and for recharging the battery bank. The system may take into account such information in determining which devices or sub-systems to dispatch in responding to expected needs.

Such a system may also be arranged at multiple hierarchical levels, such as having control at the device level, the building level, the campus level, and/or a global level (across multiple campuses in multiple different geographies and time zones). Particular types of control may be assigned to each level and may vary over time. For example, the device level may receive information dictating almost complete control of devices from a higher level under normal operation, but may switch to local control using local parameters if data from the higher level stops arriving. Similarly, computations of energy needs for each data center site may be made at a campus level, and a global controller may then receive such preliminary information to determine whether some compute should be shifted between data centers so as to better achieve a goal such as cost savings. The global controller, in such a situation, may then send information to each campus to adjust how much work each campus will do (e.g., reducing the total cooling work for the next hour at site 1 by X units, and increasing the total cooling work for the next hour at site 2 by X units), and the campus controllers may implement such updated goals.

In short, the system can “see” a number of future demands and registered resources for meeting those demands. The system can also see relevant external factors such as current and forecast ambient temperature and humidity, e.g., to determine how much power will be needed for each unit of cooling. And the system can actively interact with the grid (specifically, interact with a computer system of an electric utility that supplies the data center with grid power) to better determine how and how much power to use from different sources, including from the grid(s). Moreover, the system can update its operation as the inputs it sees change. The system also has models for the registered resources (e.g., BESSes, chillers, etc.) that are indicative of the bandwidth and stored energy levels of such resources and the costs of using the resources at different times and levels—all from which the system can schedule both the compute and the responses to the compute (e.g., for cooling) so as to minimize cost, minimize carbon generation, minimize ambient noise at certain times of day, minimize wear-and-tear on device or maximize data center availability, or similar defined goals.

In one implementation, a computer-implemented method for managing electrical and cooling supplies for a computer data center is disclosed. The method comprises identifying, for a computer data center, an expected need for cooling and electrical power during a future time; selecting, from among multiple different electrical power sources that include one or more electric utility sources, one or more electrical power sources for the data center corresponding to the future time; selecting one or more cooling sources for the data center corresponding to the future time; and serving the data center to be served using the selected one or more electrical power sources and one or more selected cooling sources over a time corresponding to the future time, wherein selecting the one or more electrical power sources and one or more cooling sources comprises applying a parameter to minimize an unfavorable result associated with operating the computer data center.

In certain implementations, the expected need for cooling and electrical power for the data center is identified as a function of present expected compute for the data center associated with the future time. Also, the unfavorable parameter can comprise one or more of electricity cost, carbon generation, ambient noise, data center availability, and equipment wear. Such selection of an electrical power source corresponding to the future time can depend on cost terms in one or more service level power agreements with one or more suppliers of grid power. The method can also comprise, in response to identifying the expected need, delaying an amount of compute by the computer data center so that the compute is performed during a period of lower cost for electrical power. In the method, the one or more cooling sources are selected based on physical parameters of multiple different candidate cooling sources, and operational parameters of the multiple different candidate cooling sources that were learned by a computer system over time. And the method can also comprise determining an energy-minimizing timing of operating the data center, and selecting the one or more electrical power sources and the one or more cooling sources as a function of the energy-minimizing timing.

In another implementation, a device containing one or more tangible, non-transitory machine-readable storage media is disclosed and stores that store instructions that, when executed by one or more computer processors, perform certain operations. Those operations can comprise identifying, for a computer data center, an expected need for cooling and electrical power during a future time; selecting, from among multiple different electrical power sources that include one or more electric utility sources, one or more electrical power sources for the data center corresponding to the future time; selecting one or more cooling sources for the data center corresponding to the future time; and serving the data center to be served using the selected one or more electrical power sources and one or more selected cooling sources over a time corresponding to the future time, wherein selecting the one or more electrical power sources and one or more cooling sources comprises applying a parameter to minimize an unfavorable result associated with operating the computer data center.

In some implementations, the expected need for cooling and electrical power for the data center can be identified as a function of present expected compute for the data center associated with the future time. Also, the unfavorable parameter can comprise one or more of electricity cost, carbon generation, ambient noise, data center availability, and equipment wear. The selection of an electrical power source corresponding to the future time can depend on cost terms in one or more service level power agreements with one or more suppliers of grid power. And the operations may further comprise, in response to identifying the expected need, delaying an amount of compute by the computer data center so that the compute is performed during a period of lower cost for electrical power.

In yet other implementations, the one or more cooling sources are selected based on physical parameters of multiple different candidate cooling sources, and operational parameters of the multiple different candidate cooling sources that were learned by a computer system over time. Also, operations may further comprise determining an energy-minimizing timing of operating the data center, and selecting the one or more electrical power sources and the one or more cooling sources as a function of the energy-minimizing timing.

In certain implementations, the systems and techniques discussed here may provide one or more advantages. For example, an integrated energy management system as described here may address a technological problem like optimizing the operation of various mechanical and electrical devices that make up a computer data center facility or facilities. They provide a technological solution by monitoring system operation for a number of many factors (e.g., different temperatures, operating states of equipment, remaining battery or fuel for certain equipment, outside data sources like weather forecasts, indications and predictions of near-future compute loads, and the like), using learning models and other factors to determine future requirements related to the compute load, determining what electrical and mechanical resources will best serve those requirements, and organizing the mechanical and electrical devices through centrally-generated computer commands to carry out the plan. In addition, the systems and methods described here further provide a technological advantage of sharing data an models about data center operation with multiple different data centers spread across geographies (e.g., that are dozens, hundreds, or thousands of miles apart). In this manner, technology is used to solved technology-centric problems to positive technical effect in the form of improved data center operation.

The details of one or more embodiments are set forth in the accompanying drawings and the description below. Other features and advantages will be apparent from the description and drawings, and from the claims.

### DESCRIPTION OF DRAWINGS

FIG. 1 is a block diagram of physical components and their interaction in a computer data center to provide power and cooling.

FIG. 2 is a block diagram showing hierarchical arrangement of control components for a system such as that shown in FIG. 1.

FIG. 3 is a flow chart showing management of cooling infrastructure in a computer data center.

FIG. 4 shows an example computer system that can be used singularly or in multiples to carry out the techniques described herein.

Like reference symbols in the various drawings indicate like elements.

### DETAILED DESCRIPTION

This document generally describes computer-based systems and techniques for managing a computer data center—both for the main computing machinery that carries out the “compute” task, and also auxiliary systems that support that main compute—such as electrical supply, heating and cooling, lighting, and control systems. The systems discussed here connect multiple electrical power sources (e.g., grid, large battery banks, gensets, and renewable supplies) and multiple power-using devices (e.g., server racks, pumps, fans, chillers, cooling towers) in a flexible manner so that the systems may select particular power sources and power-using devices in response to making a determination about what the system will need in order to operate in the near future. Such decisions can further involve communications with providers of grid energy (utilities) both generally (e.g., to set a rate schedule) and specifically (e.g., to obtain near-real-time indications of how much grid power will be available over the next x time period (hours, minutes, or seconds) so as to determine what share of an incoming power mix will be grid power and what share will be from sources internal to the system (e.g., gensets, large battery banks or BESSes, solar or wind arrays, or owned geo-thermal sources).

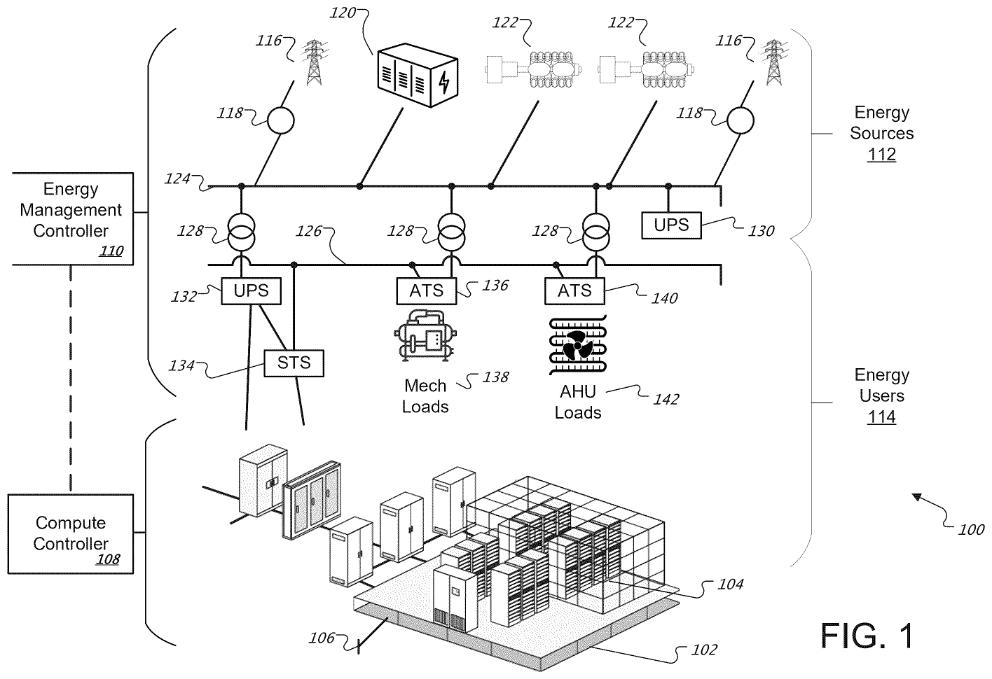

FIG. 1 is a block diagram of physical components and their interaction in a computer data center to provide power and cooling. As described above, these various components may interact to identify a future need for electrical power (including by determining a future need for cooling and other services) and to deploy the resources, as dispatchable assets, needed to meet that need, subject to certain defined goals, such as minimizing costs or carbon generation, or maximizing efficiency (e.g., running at a higher load level) or flexibility (e.g., running at a lower load level so as to leave room for future changes).

In the figure, a system 100 is shown centered around a data center 102 facility. The data center 102 may take a variety of forms and is shown in simplified form here with its walls and roof removed, and with a number of rows of computer racks 104 inside. Each of the racks 104 may contain a number of computer servers, power supplies, networking components, and the like, needed to serve a variety of demands, such as e-commerce processing, artificial intelligence (AI) processing, generation of search results, operation of back-office operations for a business (or multiple businesses in a multi-tenant data center model), and a variety of other uses. The data center 102 may be dedicated to a single tenant or may be shared among multiple tenants, either by physically demarcating machines or physical zones for certain tenants, or sharing machines among multiple tenants (e.g., using virtual machine technologies).

A data connection 106 connects the data center 102 to the internet and other relevant networks. The connection 106 can take a variety of forms, and multiple connections of multiple different or similar types may be employed so as to provide adequate bandwidth, security, and redundancy for the data center 102. Requests for computing may arrive via the connection 106 (e.g., in-coming e-commerce orders, search queries, requests for service of web pages, etc.) and the data center 102 may process those requests in appropriate manners to generate responses that can be sent out via the connection 106 (e.g., serving of web pages and other data).

A compute controller 108 provides general management of the “compute” side of the data center 102, in terms of the processing the data center conducts as part of its main role. For example, compute controller 108 may track incoming requests over time and determine a typical compute load for the data center 102, and may communicate with other off-site systems to lessen the load or indicate that free capacity is available. As a result, compute controller 108 may cause computing jobs to be scheduled over a time period of seconds, minutes, and hours, such as by receiving a request for training of an AI model that is estimated to take 10% of the data center 102 capacity for four hours. The compute controller 108 may then schedule that job for a future time period or periods, such as by breaking it up and processing portions of it over-night, when historical data indicates that the data center 102 is otherwise under less of a compute load, and when utility prices may be relatively favorable. The compute controller 108 may be or may implement the functionality of a cluster scheduler.

In a multi-tenant situation, compute controller 108 may track usage by different tenants for purposes of billing and to ensure that each tenant is receiving its contracted-for capacity and not more or less. Compute controller 108 may also apply various rules, such as by allowing over-use by certain tenants upon appropriate notice, and in limited circumstances. Also, in a multi-tenant environment, compute controller 108 may total up the total expected compute as a sum of all expected compute loads that each tenant sends in, or to which each tenant is entitled, with some corrective factor based on historical experience, so as to predict future total compute loads for a facility, site, or global system.

In addition, compute controller 108 may build models of the compute usage by the data center 102 over time, and continuously update those models so as to better schedule future compute needs. For example, the models may show a general pattern of compute activity for each day of the week across 24 hours. Such models may then be used to determine that certain types of compute load (e.g., web search or e-commerce) are likely to rise or fall a certain amount over the next n minutes or hours, and a prediction of needed data center 102 utilization for that period may be determined. The actual data for that period may subsequently be used to update and tweak the model as part of a learning process, where the model is initially and/or continuously trained on new data about compute load. Such compute model may also be muti-factored, including by incorporating indications of different types of processing, changes in the mix of processing (e.g., if a tenant has left or entered the data center 102 mix, or if the tenant needs particular types of processing such as CPUs vs. GPUs), and similar factors, so that an overall compute load can be built up from sub-models for each of the different components that produce that overall compute load. In addition, compute controller 108 may, as indicated above, schedule certain types of non-critical jobs and communicate with systems run by tenants so that the tenant systems can notify compute controller about expected compute jobs, and the two may negotiate or otherwise communicate to determine how and when the data center 102 will handle those jobs, and how much they will cost the tenant(s).

In communication with the compute controller 108 is an energy management controller 110. As the compute controller 108 monitors, models, and controls data usage by the data center 102, the energy management controller 110 monitors, models, and controls electrical power usage that is associated with the data usage (along with related functionality like cooling). A dotted line shows that the two controllers 108, 110 communicate with each other to perform such functions. As one example, the compute controller 108 (which may in common circumstances be provided by a different organization than energy management controller 110, such that the two can communicate using an agreed-upon API) may periodically or nearly continuously send to the energy management controller 110 data that indicates a compute level that the data center 102 will be seeing in the near future (the coming seconds, minutes, or hours), and that energy management controller 110 can convert that compute load into an expected heat load for the components inside the data center, like the racks 104—where that heat load will need to be removed. The compute controller 108 may alternatively determine the heat load (which may be expressed as a profile over time, regardless of what component determines it) and send that to energy management controller 110.

Energy management controller 110 may make determinations about what components to dispatch, at what level to operate them, and when to operate them, based on one or more goals, which may include minimizing energy costs, minimizing carbon footprint, minimizing other environmental effects such as external noise generation overall or at certain times of the day, maximizing data center availability, and maximizing the life span of data center components. Minimizing cost may involve shifting operations to off-peak times when energy costs are lower (e.g., at night, for grid costs), such as by delaying compute jobs that can be delayed, using a BESS or genset to provide power during peak times, shifting compute load between data centers, or other techniques. Minimizing cost and carbon or other environmental effects may also involve operating the data center more efficiently, such as by operating components in a “sweet spot” of their power curve, which might be in the middle of their operating capacity. For example, if a data center has multiple chillers rated at 100 (a dimensionless number used here for clarity) and has a projected need of 200, it may operate three chillers at 67 each (more efficiently) rather than two at 100 each (less efficiently). The operation of components away from their maximum load can also extend their lifespan and increase their availability, and thus indirectly decrease costs also.

As described here, the energy management controller 110 may be programmed to take into account each of these concerns, weight them appropriately (e.g., by converting energy costs, repair/replacement costs, and downtime costs to a common value, and minimizing that value), and determine an optimal operating path for a data center 102. Each time a data center 102 makes such operating decisions, it may also gather data on its actual performance compared to its expected performance, and may provide that data to a machine learning system as training data for updating a model that is used for making the determinations—and such model(s) may be shared between and among data centers in different geographic locations. In this way, then, the system may continuously improve. The particular type of machine learning to be used, the data to be collected, and the manner in which the data is processed, may vary based on the particular application.

As part of such processing, energy management controller 110 monitors and controls a number of components or devices that are shown schematically here to a “North” side of the data center 102, though in actual implementation, they would be located where physical practicalities dictate, e.g., to lessen the need for complicated piping, to permit access to the components (e.g., perhaps with heavy equipment) and to other parts of the data center, and by other considerations. As shown in the example here, the components generally fall into two groups: energy sources 112 and energy users 114.

The energy sources 112 may generate electricity initially and/or may store and later provide electricity generated by another source. Shown here, there are two distinct grid sources 116, whereby a data center may negotiate to have electricity provided by two different utilities, so as to improve capacity, cost, and reliability. Each grid source 116 is shown connected to a medium voltage (MV) electrical bus 124 via a meter 118 by which electrical use by the data center 102 from the respective grid can be measured for, e.g., billing purposes. The meter 118 or an area near it may also define the relative responsibilities of the utility and the data center 102 operator for maintaining and repairing equipment in the system 100. The MV bus 124 may in turn be connected to a low voltage (LV) bus 126 via respective transformers 128. The buses 124, 126 may be fully or partially conceptually parallel to each other, and as needed, particular components may connect to the MV bus 124 rather than the LV bus 126 or vice-versa, depending on the implementation and component needs.

Another source is a group of large battery banks 120, e.g., equal to or greater than 1 MWH each, or total, and may take the form commonly known as a battery energy storage system (BESS), which includes the battery cells and associated management and control resources. The banks 120 may use a variety of chemistries and may be sized to operate the data center 102 for a certain minimum necessary time period at a typical load, such as 30-60 minutes or one hour or several hours or 24 hours. As described more fully below, the banks 120 may be used to provide power during limited time periods when power is not available from larger sources such as the grid, to provide additional power above that is available from other sources, to allow for smooth shutdown of the components in the data center 102 under certain emergency conditions, to load shift by charging the banks 120 during the night and discharging them during the day, and other similar uses.

The other energy sources are gensets 122, in the form of natural gas or other-powered engines powering generators, again connected to the MV bus 124. Other energy sources may also be provided, such as small-scale fusion, water circulating through geothermal loops, wind generators, piezoelectric solar, hydrogen-cell generation, and the like. While such sources will generally be operated by the operator of the data center 102 or by a separate utility, they may also be operated by a dedicated third party, such as a syndicate that develops power sources to be served mainly or solely to a small group of data centers under contract, such that the syndicate would not be a full-blown utility.

The energy users 114 include the various main components that require electrical power as part of the operation of data center 102. For example, a UPS (uninterruptible power supply) 132 and STS (static transfer switch) 134 may connect the LV bus 126 to the servers 104 and other electrical components that are part of the data processing for the data center 102. The STS 134 may normally carry power from the bus 126, while the UPS 132 charges from the bus 126, and when there is no power from the bus 126, the UPS 132 may automatically and quickly activate, and the STS 134 may simultaneously switch so that the compute infrastructure of the data center 102 is provided from the UPS 132. Such functionality may also be incorporated with a BESS so that, depending on the situation, the BESS may quickly switch upon indication of an interruption so as to provide uninterrupted supply, and in non-emergency situations can provide a scheduled switch so as to provide power that is desired (e.g., to permit load shifting) but not required in the manner UPS power would be.

Other energy users 114 include mechanical loads 138 which are connected to both buses via an ATS (automatic transfer switch) 136. The mechanical loads 138 may include, for example, chillers, cooling towers, and related pumps. Further down the cooling system are AHU loads 142 also connected by an ATS 140. The AHU loads may include fans and other pumps that circulate warmed air and cooling water through coils to effect heat transfer out of the data center 102. The cooling water may circulate into the data center 102 building to the AHU loads 142, may gain heat there, and may then circulate outside the main building and through chillers or cooling towers as part of the mech loads 138.

Finally, a separate UPS 130 is provided to operate the LV bus 136. As noted, such functionality may be stand-alone as shown, or may be integrated with other functions related to delivery of stored electrical energy, such that the BESS may be used in certain implementations to provide such back-up power.

In operation, energy management controller 110 may take in information from a variety of sources to determine how much cooling will be needed for data center 102 in the near future, and then how much electrical power will be required to achieve that cooling (and also the electric power needed to perform the compute operations that create the heat that requires the cooling). The sources include, for example, information that allows the level of compute to be converted to an expected level of heat generation (which may come from learning models), current and future ambient temperature and humidity for the area around the data center 102 for the relevant time period, information about the efficiency and operability of particular energy sources 112 and energy users 114, and models that relate such other variables to relevant needs for electric power. The information about the operability of particular energy sources may include information about whether certain devices are currently on-line or off-line, e.g., for maintenance or repair. For example, a chiller manufacturer may provide, in memory shipped with the chiller or at an on-line resource accessible over the internet, an indication of electrical power required to operate the chiller at different tonnage levels, and the system can access such information in determining how much electricity will be required to provide n tons of cooling for the time period under certain ambient air conditions. (As noted elsewhere, the system may also learn the operating parameters of a particular chiller over time, and may supplement or replace the manufacturer data with real, observed data.)

Energy management controller 110 may use such information to determine how much cooling and electrical power will be needed over a defined future time period, and may take actions to make such cooling and power available. For example, energy management controller 110 may provide information to a related computer operated by a utility 116 to indicate future needs for electrical power and/or may consult data about the rate agreement the data center 102 has with the utility 106, to determine whether to use power from the particular grid during the defined period (and how much power to use). Energy management controller 110 may check with one or more of the energy users 114 to confirm that such user is available for operation, and may consult data on each such device's capacity levels (e.g., in BTUH, and an associated electric usage at that design level).

Energy management controller 110 may also be programmed so as to make data center 102 an active grid participant. For example, energy management controller 110 may dynamically negotiate with one or more grids/utilities for electric pricing for upcoming periods (seconds, minutes, or hours), such that each grid can look at its current capacity and provide a lower bid (lower than a previously-negotiated agreement) if its current and near-future capacity is relatively high—and where the parties can agree to the delivery of a certain amount of electric power for a certain price. Energy management controller 110 can also send a utility 106 information about its anticipated future needs for electric power, so as to enable the utility 106 to better manage its system, such as by maintaining certain turbines and generators in operation if the data center 102 indicates that it will have a high power need in the near future.

Such information about needs and availability may run in both directions (from energy management controller 110 to utility 106, and vice-versa) and occur repeatedly, so that the two entities are constantly updating each other on needs and supplies. As one example, energy management controller 110 may have an indication that, by a rate agreement, the cost of power will fall in 60 minutes. But it may have a need to perform some level of compute sooner, and thus may send the utility 106 a request to obtain power at the reduced rate starting an hour early—a request that the utility 106 may satisfy if its systems tell it that it will likely have excess capacity over the next hour. Information flow and power flow may also be reversed, in that the utility 106 may request information about power that the data center 102 might be able to provide to the grid, such as by turning on certain gensets or depleting certain battery banks. The two may agree on an amount of power over a certain time period, and may control their respective systems to make power flow back onto the grid, and for data center 102 being credited monetarily or otherwise for the provision of the power.

Energy management controller 110 may perform “load shaping,” such as controlling when compute is to be performed (where some of the compute is not time-sensitive) or delaying the onset of cooling or other services. As such, energy management system 110 may prevent the load from exceeding a determined maximum, while maintaining the load near the maximum—i.e., to flatten the load overall. Such load shaping may also have discontinuities nears changes in pricing or other goals, such that load may be increased step-wise at night after rates fall, or may be decreased or otherwise altered at night (e.g., operate components away from a populated area) if ambient noise around a data center is a consideration. Such load shaping may also occur even if the data center operator does not own or otherwise control the load.

For example, an interface may be provided between energy management controller 110 for a data center 102 and systems operated by one or more tenants (e.g., in a cloud, multi-tenant operation) whose compute is handled by the data center 102. The interface may institute a dialogue by which energy management controller 110 offers lower compute pricing if the tenant allows a certain amount of their compute load to be delayed, or an auction with multiple tenants. Energy management controller 110 may initially inquire of the tenant about its flexibility—e.g., to indicate how much of its anticipated needs are not time-sensitive and how long they may be delayed. If such tenant information meets the load shaping needs of energy management controller 110, then energy management controller 110 may offer a certain discount and the tenant may respond by accepting or rejecting the discount. Such communication may occur automatically (and quickly) between the data center 102 and tenant systems, and may occur many times per hour or day.

Such load shaping for power purposes may also be provided as an adjunct to normal load shaping that the data center 102 may perform with its tenants, that is directed to making sure the compute capacity is not suddenly overwhelmed by near-simultaneous requests from multiple tenants. In this manner, energy management controller 110 may have successive communications with utilities and its tenants over a short period of time (seconds or minutes) to determine both the utilities'flexibilities and price-sensitivity to delivering power at certain times, and its tenants'flexibilities and price-sensitivities about having compute performed during certain times, so as to shape a compute curve and power curve cooperatively in a manner that minimizes or maximizes a desired goal, such as electrical spend as compared to compute revenue.

Energy management controller 110 can also communicate with one or more grids 116 about power that the data center 102 could provide to the grids (rather than take from the grids). For example, data center 102 may have control over a BESS, genset, or renewable energy source (e.g. wind or solar or geothermal), where the source has the ability to provide more power than the data center 102 will currently need—either for its expected near-future needs or if the data center 102 delays certain compute projects and thus lowers its own expected power needs. In such a situation, the data center 102 may communicate with one or more grids, indicating the timing and amount of power that it might be able to make available to them. The grid(s) may then each indicate whether they have a need for such power. Thus, for example, data center 102 may find that it has fewer compute jobs in the afternoon, when cooling loads for customers of a grid are at their maximum, and data center 102 may then “sell” power back to the grid 116, e.g., to offset what it would otherwise owe to the grid. Such a process may also be instituted by a grid 116, such as the grid 116 recognizing that it will have a defined “down time” for a portion of its generating structure due to planned maintenance, such that the grid may schedule a time and amount of power that it will receive from the data center 102, which may in turn charge its BESS to deliver such power at the relevant time, or prepare to power up one or more gensets to provide the power. These dialogues may be fully automatic (e.g., with the energy management controller 110 automatically determining its future needs and either consulting a rate schedule or performing an ad hoc auction or negotiation over rates) or partially automatic (e.g., with a person operating the energy management controller receiving a recommendation from the system, and then indicating whether a proposed transaction with the grid should occur). In this manner, the data center 102 operator may serve as a cooperative partner with the grid 116 operator even though they are two different corporate organizations with their own needs and interests. More broadly, data center 102 may periodically (e.g., every minute) send a notification to its utilities about whether it is undersubscribed, evenly subscribed, or oversubscribed (or could break the levels into n different levels of severity rather than the three just mentioned), and the utilities can thus be kept up-to-date on whether an inquiry from them to receive power from the data center would be likely to be positively or negatively received.

The system 100 shown here may also allow more modular deployment and management of data center 102 components. For example, particular energy users may be manufactured as plug-and-play modules that can be physically connected to system 100, with valves (or switches) then opened, and the added energy user 114 or source 112 may immediately provide cooling or other services. That module may then be disconnected and added at another site in a similar manner. Or piping stubs and electrical circuits and connections may be built initially with isolation valves/switches for n multiple taps along a piping or electric circuit. Data center 102 may initially become operational with only 1 of n devices in operation, and as computer servers are added inside the data center 102 building, modular devices can be added in coordination (and by matching capacity to the amount of compute load that currently exists in the facility), one-by-one (or otherwise in discrete steps) until all the taps are taken and the system is at full operation. Where previously-defined interfaces (e.g., for data connections, piping connections, and electrical connections) for connecting equipment is followed, needed on-site labor may also be substantially reduced.

The system 100 may also be readily operated at different levels of capacity based on decisions made by energy management controller 110. For example, certain system components may have high reliability and/or high efficiency when operated at 70% of capacity (or below), so that energy management controller 110 can seek to stay at or near 70% during most operation. However, if a compute load arrives that needs to be performed quickly, energy management controller 110 can determine how much of the compute load can be handled per minute while running the energy users 114 at perhaps 90% or 100% of capacity, and can achieve the processing with a short period of full-speed operation or over-subscription. Or if 100% operation is needed to meet the load, energy management controller 110 can operate the cooling components at 80-90% but run them for a longer time period, so that temperatures might rise slightly since the compute load exceeds the cooling load for a time period (perhaps several minutes), but then the cooling can exceed the heat load from the compute for a time, and bring the system 100 back into balance.

Similar considerations may come into play for the system to maintain steady operation during an afternoon period that is particularly warm. There, energy management controller 110 may determine from publicly-available forecast information that extreme heat will last 3 hours, and then the ambient temperature will drop because of an arriving cold front. Energy management controller 110 may thus cause the energy users 114 that perform cooling to operate at high levels for the three hours (and may draw down the charge on battery banks 120), knowing that the over-sized demand will be over in about three hours.

Energy management controller 110 may consider the various components that it controls as being fairly generic dispatchable assets. It may be programmed to understand, from a model, their effect on electrical supply available on the buses or their effect on cooling water available in a chilled water loop, without having to be concerned with further details of their internal operation. In such a situation, the controller, in determining which devices to send commands for operation, may look just to the device parameters that matter to its computations, and select particular devices and operational variables for those devices—and then send commands to achieve such ends in a basic dispatching model.

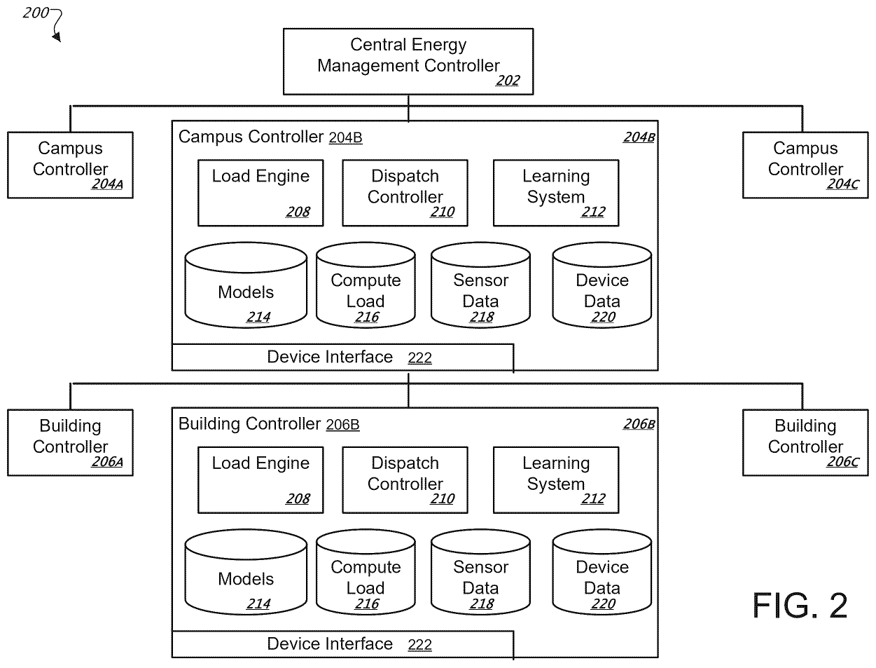

FIG. 2 is a block diagram showing hierarchical arrangement of control components for a system such as that shown in FIG. 1. For simplicity, in FIG. 1, a single data center 102 building is shown and discussed. But data centers may be cooperatively controlled, both at a single site and across multiple geographically-distributed sites across an entire country or across the world (e.g., more than a mile apart and as much as thousands of miles apart). FIG. 2 illustrates an example of how a system 200 can use components like those shown in FIG. 1 to effect coordinated control and operation of a data center system at many sites.

In the figure, the system 200 is implemented as a three-level hierarchy. At the bottom level are building controllers 206A-C, which may correspond to energy management controller 110 in FIG. 1. The building controllers 206A-C each monitor and control the energy flow for a particular building on a data center campus. At the middle level are campus controllers 204A-C, which can either directly monitor and control each of multiple data center buildings at a particular geographic location (a campus), or can obtain information from and provide control instructions to, one or more building controllers 206A-C located at the particular campus. At the top of the hierarchy is a central energy management controller 202, which receives data from and provides control information to multiple different campuses. Each of the controllers at the different levels of the hierarchy can run a different instantiation of a common control application or data center operating system, though they may be configured with different user interfaces, sub-applications, and privileges as is appropriate for the particular level. And each level may be able to communicate with its adjacent level or all other levels through appropriate APIs and also secure protocols that prevent third parties from listening to or interfering with the data center information gathering and control.

The building-campus interaction may occur in a number of manners and provide a number of benefits. For example, building controllers may be more local to particular end devices and may more granularly and efficiently manage them, and provide for a user interface at the particular building which is not confused by displays for other buildings. The campus system may then incorporate inputs from the various buildings, and may develop models from such data to apply to predictions made across all the buildings—though such models may recognize differences for each of the buildings, such as orientation toward the sun, types of server systems, and the like. As such, a central manager may coordinate so that load is shared among and shifted among the individual buildings as needed.

The campus-central interaction may likewise occur in a number of manners and provide a number of benefits. For example, the relevant user interfaces may again be directed to what is relevant to the particular user—even though each level may use the same application or operating system, but may employ different features of it. For example, the central controller 202 may store data across all buildings and all campuses, and may perform complex analysis from such data. It may also make certain campuses aware of capabilities at other campuses, such as to shift some compute from a geography where it is currently warm and/or day time (so electrical rates are high) to one where it is dark and/or cool (so lower rates). The system 200 via controller 202 may likewise give campuses access to data and tools that are relevant to them, while providing security so that one user's or campus'data is not shared without providing appropriate compiling or other anonymization first.

Particular example components of a controller are shown with campus controller 204B, and are repeated with building controller 206B, though different components may be activated for the different levels and at other controllers at the same level, and access to applications or data may be dependent on the level at which the system is activated (with higher levels generally having broader access) or the role of the user logged into the account (where managers have more access and technicians less).

Referring specifically to example controller 204B, the controller can rely on a number of components as part of determining the loads that its sub-system will face in a coming time period, and providing control of various devices. As an initial matter, a device interface 222 may provide for APIs and other communication with particular devices like chillers, fans, cooling towers and the like. Such devices and the controllers may be connected to a local area network when they are first installed, and the devices may declare themselves to the system and be registered with the controllers. For example, a device may provide an identifier for itself, and the controller 204B may use that identifier to obtain information online about the device, such as its cooling capacity, maintenance schedule, and other related information. Alternatively, or in addition, a device may itself provide controller 204B with such parameter information about the device. After such enrollment and registration, controller 204B and all registered devices may communicate with each other through the interface 222, such as a device reporting its current operating condition parameters to the controller 204B (e.g., entering and exiting water temperatures for a chiller), and the controller sending control information to the device, such as to cause the device to operate according to different setpoints than it is currently operating. Though described as communicating with controller 204B here, the devices may more appropriately or additionally communicate with controller 206B, which may then consolidate information or route commands to/from controller 204B (as may be true with other components or operations described below).

Also within the controller 204B are several components that carry out analysis of information received from the controller 204B and various databases that the controllers obtain from one other to carry out such analysis. As to the analysis components, a load engine 208 carries out calculations to determine the level of electric load that a data center, campus, or worldwide operation will face in the near future. For example, load engine 208 may obtain information from a public weather service about forecast temperature and humidity in an area around a particular data center for an upcoming minutes or hours, may obtain information about an expected compute load over that time period, and may determine how much heat such load will generate, and how much electricity will be required to mitigate the effect of the heat.

A dispatch controller 210 may act on the determinations made by the load engine 208. For example, if the load engine determines that a certain number of BTUH will be required for cooling over the next 30 minutes to offset heat created by racks of servers in a particular data center, the dispatch controller may (a) identify which cooling devices are available (e.g., registered and not subject to current repair or maintenance), and (b) determine how much cooling each such device can provide. For example, using dimensionless numbers for simplicity, if the need for cooling is 500, and the system has chillers whose continuous operation is 100, 200, 300, and 500, the dispatch controller could select either the fourth chiller or the second and third chillers together to run over that time period. Such a decision may depend on, for example, the relative electrical efficiency of each choice, on a desire to even out the number of hours of operation on each chiller, on an understanding that the need will fall a bit after the 30 minutes (such that the 200+300 option could be stepped down to just 300, and may thus be superior to the 500 option), on seeing data indicating that one of the chillers may soon be in need of maintenance, and other such considerations. When the dispatch controller 210 has made such determination, it can cause control signals to be transmitted out to the relevant devices over the LAN via device interface 222. Or it may send instructions to building controller 206B, which may then forward the instructions to the relevant device(s) or may use any received information to generate its own form of information to be provided to the end devices. In addition, the dispatch controller 118 may be used to cause control to be passed between different data centers, upon a determination that certain compute should be performed at such particular campus or data center (e.g., because one campus has favorable utility pricing or a greater amount of free capacity over the defined time period).

At box 212 of campus controller 204B is a learning system 212. That component is programmed to incrementally train the system 200 to more accurately predict electric and other needs. For example, after load engine 208 and dispatch controller 210 cause the system 200 to be operated in a certain manner after they obtain information about approaching weather and approaching compute needs, the learning system 212 can determine whether the system 200 accurately maintained an appropriate state of the system 200 (e.g., air temperature at the servers). If it did or if it did not, the learning system 212 may use such variance or lack of variance to update a model of the system 200. For example, if the prediction provided too much cooling capacity over the most recent defined time period, the training of the system 200 on such new information may cause the model of the cooling and electrical system on which the load engine 208 relies to adjust away from that error, such as by lowering the amount of heat generated by each unit of compute in the model, updating the efficiency of certain cooling components, or changing the modeling of ambient temperature and humidity effect on the recommendations generated by the system 200.

The learning system 212 may operate both locally and globally. In particular, a learning system 212 in a building controller 206A-C that implements a new type of power or cooling technology may learn, through actual operation and generated training data, the particular real-world reaction of that new type of technology (e.g., a new chiller). It may then provide such measured data or modeling to one or more campus controllers 204A-C, or to a central energy management controller 202. The more central controllers may then integrate the data so that it can be used by other portions of the system—e.g., it may use training data from a first data center that installed and operated a certain type or size of BESS to be available to other data centers as soon as they install the same (or operationally comparable) type or size of BESS.

Moving to the example databases used by the campus controller 204B, there is first a models database 214. It contains data that define the models just discussed, which are used to convert various inputs into a prediction of how much electric power will be needed over a certain defined time period. The compute load database 216 contains data needed to convert a particular level of compute operations to a particular level of generated heat for any facility or part of a facility (which will depend, for example, on the type of compute and on the type and number of GPUs and CPUs and other components that take part in such compute). Sensor data database 218 may include both current and historical data from various sensors, which data may be used to update the models 214. For example, the sensor data may include ambient temperature and humidity readings taken at the data center, water in/out temperatures for chillers and air handling units, air temperatures inside a data center, and other such sensor data, which may be time-associated so that, for example, ambient temperature data can be used in determining the ability of a chiller to provide cooling under different conditions. And device data database 220 includes information about the various energy sources and energy users, such as data that graphs the relationship between cooling provide by a chiller at different load levels, and electricity demanded by the chiller at such level(s).

As an example of hierarchical flow of information through system 200, consider a central energy management controller 202 coordinating operation across multiple different sites. For example, a single company may want to aggregate data from different locations to create better models or to help manage operations on a broader, and thus more efficient or flexible, basis. Or a company that provides system 200 to multiple different customers can operate central energy management controller 202 to aggregate data across multiple customers, and then return more powerful (and fully anonymized) aggregated data. Thus, for example, a data center in a low-humidity area may otherwise have an incomplete or unsophisticated model for high-humidity situations, but may take advantage of data from a different data center that frequently faces high humidity.

As another example, each local campus may compute its electric needs over a defined time period (e.g., minutes or several hours) and submit them to the central energy management controller 202, which may in turn compute the costs of using grid or other power in each location to deal with “local needs.” The controller 202 may determine that, for the defined time period, one of the locations has much more favorable pricing for electricity, that that location has compute capacity available, and may cause the compute to be transferred for performance at that less-expensive location. In this manner, a target goal can be met more often and more readily, by seeking that goal across multiple buildings and multiple campuses.

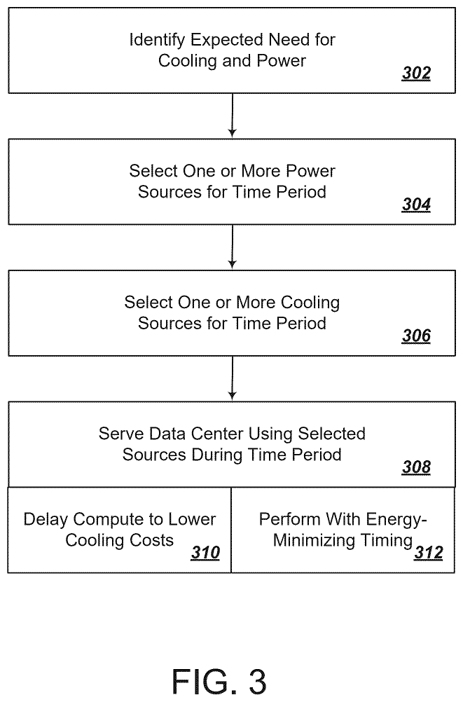

FIG. 3 is a flow chart showing management of cooling infrastructure in a computer data center. In general, the pictured process shows how both power sources and devices that use electrical power can be selected for a time period in the operation of a data center so as to minimize some identified deleterious result, such as minimizing overall electrical use, minimizing carbon generation, minimizing wear on machinery, and the like.

The process begins at box 302, where an expected need for cooling and power is identified. As one example, a system may periodically (e.g., once every 5, 15, 30, or 60 minutes) determine how much power will be needed to keep a data center (or campus) operating at nearly a steady state (e.g., without over-heating chilled water systems, etc.). Such determination may initially involve obtaining data about how much compute load the data center is expected to face during that time period, which may be based on known compute jobs that need to be performed as well as on predictions about the flow of new compute requirements (e.g., generating web pages in response to search requests or e-commerce activity). With the compute known, an amount of heat likely to be generated by that compute can be determined (plus residual heat such as humans in the building, lighting heat, motor heat, etc.). And then an amount of electricity needed to dissipate that heat may be determined. Such determination may be made by referring to data about the efficiency of a cooling system in removing heat relative to the amount of electricity consumed by the system, as discussed above.

At box 304, one or more power sources are selected for the time period. As an initial matter, the power source may be selected which can provided all or most of the needed power for the time period. A power source that cannot itself supply all the power could nonetheless supply some power in combination with another source of electric power. Cost may be a major factor in selecting a source. For example, if a pricing agreement with a utility is superior to all other sources and the utility confirms that it can provide the necessary power at the time period, then the grid may be selected as the sole power source. In contrast, if utility prices are currently high, a large battery bank is currently fully charged, and utility prices will drop in a few hours, a combination of the batteries and utility may be selected, and the batteries can be recharged from the utility source as soon as the lower rates kick in.

At box 306, one or more cooling sources are selected for the time period. For example, the process may check ambient conditions and determine that free cooling will be sufficient under the circumstances so that only fans and actuators needed to effectuate free cooling will be needed. Alternatively, if the ambient air is warmer, then a number of chillers may be selected so as to meet the expected cooling needs during the period. In this example, the cooling sources may be selected before the power sources so that the particular amount of power needed to operate the cooling source(s) can be identified before needing to select a particular power source. Generally, the selections at boxes 304 and 306 will occur near simultaneously rather than sequentially, which may allow collaborative selection of power sources and cooling sources—where different selections for each may be made initially, and metrics may be applied against those selections to determine which of the initial selections best meets the system's operational goals (e.g., low cost, high availability, etc.). The order of other steps may also vary and overlap according to the needs of a particular implementation. Also, all or some of the process may be iterative, such as involving rough estimates initially to determine which sites or sub-systems are capable of providing the needed compute, cooling, or electric power, and then determining which can do so while maximizing or minimizing one or more decision criteria.

At box 308, the data center is served during the time period using the selected sources. For example, a switch may be automatically set to connect a bank of batteries to a power bus so that at least a portion of the electricity used by the data center during the time period is supplied by the battery bank. If the battery bank falls below a target charge level (e.g., 10 or 20%), the remainder of the time period could be served exclusively using utility power. The particular time period can be more or less defined. For example, it could be a particular time period—e.g., the next 30 minutes, or 1:30 pm to 2:00 pm. It can also be more general—e.g., the time needed until compute project X is completed.

The service of the data center may be performed with certain case-specific limits. For example, at box 310, the serving of the data center is delayed in whole or in part so as to lower cooling costs. For example, if utility rates will fall substantially in only a few minutes, the performance of certain compute tasks that are not time-critical may be delayed to that time, and/or a BESS may be used to bridge that gap. And box 312 indicates performing the tasks needed to serve the data center using energy-minimizing timing. Here, for example, certain operations may be carried out at night, when cooling towers and chillers may operate more energy-efficiently in the face of lower ambient temperatures.

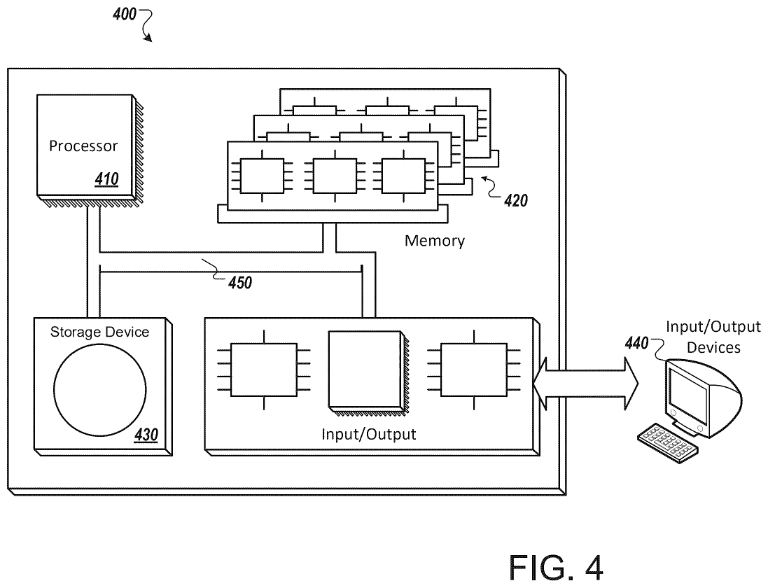

FIG. 4 is a schematic diagram of a computer system 400. The system 400 can be used to carry out the operations described in association with any of the computer-implemented methods described previously, according to one implementation. The system 400 is intended to include various forms of digital computers, such as laptops, desktops, workstations, personal digital assistants, servers, blade servers, mainframes, and other appropriate computers. The system 400 can also include mobile devices, such as personal digital assistants, cellular telephones, smartphones, and other similar computing devices. Additionally the system can include portable storage media, such as Universal Serial Bus (USB) flash drives. For example, the USB flash drives may store operating systems and other applications. The USB flash drives can include input/output components, such as a wireless transmitter or USB connector that may be inserted into a USB port of another computing device.

The system 400 includes a processor 410 (e.g., CPU or GPU and related components), a memory 420, a storage device 430, and an input/output device 440. Each of the components 410, 420, 430, and 440 are interconnected using a system bus 450. The processor 410 is capable of processing instructions for execution within the system 400. The processor may be designed using any of a number of architectures. For example, the processor 410 may be a CISC (Complex Instruction Set Computers) processor, a RISC (Reduced Instruction Set Computer) processor, or a MISC (Minimal Instruction Set Computer) processor.

In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, an SSD, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device.

A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks, SSDs, and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method for managing electrical and cooling supplies for a computer data center, the method comprising:
identifying, for a computer data center, an expected need for cooling and electrical power during a future time;
selecting, from among multiple different electrical power sources that include one or more electric utility sources, one or more electrical power sources for the data center corresponding to the future time;
selecting one or more cooling sources for the data center corresponding to the future time; and
serving the data center to be served using the selected one or more electrical power sources and one or more selected cooling sources over a time corresponding to the future time,
wherein selecting the one or more electrical power sources and one or more cooling sources comprises applying a parameter to minimize an unfavorable result associated with operating the computer data center.

2. The computer-implemented method of claim 1, wherein the expected need for cooling and electrical power for the data center is identified as a function of present expected compute for the data center associated with the future time.

3. The computer-implemented method of claim 1, wherein the unfavorable parameter comprises one or more of electricity cost, carbon generation, ambient noise, data center availability, and equipment wear.

4. The computer-implemented method of claim 3, wherein the selection of an electrical power source corresponding to the future time depends on cost terms in one or more service level power agreements with one or more suppliers of grid power.

5. The computer-implemented method of claim 1, further comprising, in response to identifying the expected need, delaying an amount of compute by the computer data center so that the compute is performed during a period of lower cost for electrical power.

6. The computer-implemented method of claim 1, wherein the one or more cooling sources are selected based on physical parameters of multiple different candidate cooling sources, and operational parameters of the multiple different candidate cooling sources that were learned by a computer system over time.

7. The computer-implemented method of claim 1, further comprising determining an energy-minimizing timing of operating the data center, and selecting the one or more electrical power sources and the one or more cooling sources as a function of the energy-minimizing timing.

8. A device containing one or more tangible, non-transitory machine-readable storage media that store instructions that, when executed by one or more computer processors, perform operations comprising:
identifying, for a computer data center, an expected need for cooling and electrical power during a future time;
selecting, from among multiple different electrical power sources that include one or more electric utility sources, one or more electrical power sources for the data center corresponding to the future time;
selecting one or more cooling sources for the data center corresponding to the future time; and
serving the data center to be served using the selected one or more electrical power sources and one or more selected cooling sources over a time corresponding to the future time,
wherein selecting the one or more electrical power sources and one or more cooling sources comprises applying a parameter to minimize an unfavorable result associated with operating the computer data center.

9. The device of claim 8, wherein the expected need for cooling and electrical power for the data center is identified as a function of present expected compute for the data center associated with the future time.

10. The device of claim 8, wherein the unfavorable parameter comprises one or more of electricity cost, carbon generation, ambient noise, data center availability, and equipment wear.

11. The device of claim 10, wherein the selection of an electrical power source corresponding to the future time depends on cost terms in one or more service level power agreements with one or more suppliers of grid power.

12. The device of claim 8, wherein the operations further comprise, in response to identifying the expected need, delaying an amount of compute by the computer data center so that the compute is performed during a period of lower cost for electrical power.

13. The device of claim 8, wherein the one or more cooling sources are selected based on physical parameters of multiple different candidate cooling sources, and operational parameters of the multiple different candidate cooling sources that were learned by a computer system over time.

14. The device of claim 8, wherein the operations further comprise determining an energy-minimizing timing of operating the data center, and selecting the one or more electrical power sources and the one or more cooling sources as a function of the energy-minimizing timing.
